(19) United States
(12) Patent Application Publication
(10) Pub. No.: US 2005/0080699 A1
(43) Pub. Date: Apr. 14, 2005

(54) Savings and investment method

(76) Inventor: George Brown Snelling, Rochcdale (AU)

Correspondence Address: KOLISCH HARTWELL, P.C., 520 S.W. YAMHILL STREET, SUITE 200, PORTLAND, OR, 97204, US

(21) Appl. No.: 10/961,583

(22) Filed: Oct. 8, 2004

(30) Foreign Application Priority Data
Oct. 10, 2003 (AU) 2003 905 533

(51) Int. Cl. G06F 17/60

(52) U.S. Cl. 705/35

(57) ABSTRACT

A savings and investment method where a first party rents at least one wholly-owned investment property to at least one second party; deposits all net income received in an account, charges all living expenses to a credit facility, periodically clears the balance of the credit facility with funds from the account to avoid paying interest on the credit facility; and saving money in the account. The method may also be applied to dividend income from shares/securities.

### FIELD OF THE INVENTION

The present invention generally relates to saving and investing money. In particular, although not exclusively, the invention relates to a method of saving and investing money involving purchasing property.

### BACKGROUND TO THE INVENTION

There are many different ways to invest and save money, such as depositing money into bank accounts, fixed term deposits, bonds, stocks, shares, equities and the like. However, often interest received on bank accounts and term deposits and the like is low resulting in paltry returns. Investing in the stock market is subject to the vagaries of the economy and other often seemingly unrelated factors that can see one's investment vastly diminished practically overnight.

Purchasing property is perceived as an excellent investment since the value of property almost always increases. For example, in Australia, the value of property has appreciated at least 7.2% per annum for approximately the past 100 years. Many people enjoy owning one or more second properties in addition to the property in which they usually reside. These so-called investment properties can provide a regular income stream by renting out the property, the rental income often being used to pay off a mortgage on the investment property.

One problem in purchasing property is the large cost, which is often a barrier to first time buyers. Additionally, conventional mortgages cannot only be difficult to pay for on a periodic basis, eg., fortnightly or monthly, but they can take several decades or more to pay off. For example, if $250000 is borrowed for a mortgage at an interest rate of 7.5%, typically, the monthly repayments may be in the order of $1800 for a period of 25 years. This results in over $300000 in interest being paid over the mortgage term—more than 120% of the amount borrowed.

Such frustrating scenarios have resulted in alternative mortgages and loan schemes being developed and offered. One such alternative is a line of credit loan, which usually involves one or more persons's salary or wages being paid directly into the loan account and the person living off their credit card for day to day living costs and expenses. The maximum amount of money is being deposited into the loan account to reduce the principle and interest and the balance of the credit card is paid off each month to avoid paying credit card interest. The result is that less interest is paid and the loan is paid off more quickly. For example, for the same $250000 borrowed at the same rate as in the example above, if a person's monthly income was $3000 and their monthly expenses amounted to $1000, around $66000 can be saved in interest payments and the loan can be paid off in around 20 years rather than 25.

However, some line of credit loans attract higher fees to compensate for the loss in earned interest. Also, some people find it difficult to adjust to using a line of credit loan since strict adherence to a predetermined budget is required. Consequently, some people fall into financial trouble with line of credit loans.

Saving money becomes of even greater concern once people retire, since there Is no longer income from employment and a retiree's only income may be from a private pension or superannuation fund. Even if a retiree is fortunate enough to have an additional income from another source, the pension is reduced once the income exceeds government-set threshold. For example, in Australia, a single person may receive an income in addition to their pension of $116 per fortnight without affecting their pension. Thereafter, the pension is reduced by 40 cents for every dollar of income earned. For a couple, the fortnightly amount is $204. Additionally, the increased cost of living and deteriorating health increase the financial burden on retirees causing them to go out less. Hence, it can be very difficult for retirees in particular to save money.

Hence, there is a need for a system and/or method for saving and investing money that ameliorates one or more of the aforementioned problems or provides a useful commercial alternative.

In this specification, the terms “comprises”, “comprising” or similar terms are intended to mean a non-exclusive inclusion, such that a method, system or apparatus that comprises a list of elements does not include those elements solely, but may well include other elements not listed.

In this specification, the term “investment property” is intended to mean a property purchased by an entity that is not their primary residence and is purchased for the purpose of making money.

### DISCLOSURE OF THE INVENTION

In one form, although it need not be the only or indeed the broadest form, the Invention resides in a method of saving or Investing money including the steps of:

a first party renting at least one wholly owned investment property to one or more second parties;

said first party depositing all net income received as rent for renting said at least one investment property, and (optionally) at least part of an income from another source, into an account;

said first party charging their living expenses/outgoings to a credit facility and clearing the balance of the credit facility periodically with funds from said account to avoid, or minimise, paying interest on said credit facility; and

said first party accruing money in said account.

In a second form, the present invention resides in a method of saving or investing money including the steps of:

a first party purchasing shares or like securities and depositing all net income received as dividends or like financial payments from said shares or like securities, and (optionally) at least part of an income from another source, into an account, said first party charging their living expenses/outgoings to a credit facility and clearing the balance of the credit facility periodically with funds from said account to avoid, or minimise, paying interest on said credit facility; and

said first party accruing money in said account.

The term “shares and like securities” shall include shares, deposit receipts, options and fixed- and variable-interest debentures issued by governments, banks, other financial institutions and corporations.

Preferably, the first party fully owns their own residential property and purchases the, or each, investment property, or the shares or like securities by regular payments prior to retirement.

Preferably, the investment property is rented and all net rental income is applied to the loan/credit facility used to purchase the property.

Preferably, the first party does not raise any other borrowings against their equity in the, or each, investment property, or the shares or like securities, to achieve the maximum capital growth thereon.

The income from another source may be, or include, an index-linked part pension.

Preferably, the first party structures his/her finances so that the non-cash benefits of the pension are not lost, eg., to provide health care, transport concessions and the like.

The credit facility may be a credit card, (preferably with an interest-force period), a revolving line of credit or other suitable credit facility (which preferably does not apply redraw fees).

Further features of the present invention will become apparent from the following detailed description.

### BRIEF DESCRIPTION OF THE DRAWINGS

To assist in understanding the invention and to enable a person skilled In the art to put the invention into practical effect, preferred embodiments of the invention will be described by way of example only with reference to the accompanying drawings, wherein:

FIG. 1 shows a flowchart representing the method according to one embodiment of the present invention;

Annexure A is an example showing how the investment property is purchased before retirement;

Annexure B is an example of a retirement plan using the method of the present invention applied to shares.

### DETAILED DESCRIPTION OF PREFERRED EMBODIMENTS OF THE INVENTION

A person intending to retire, eg., at 60 or 65 years of age, and who wholly owns his/her principal residence, purchases at least one investment property, for example, at a purchase price of $200,000, using a housing loan on a line of credit.

The investment property is rented with, eg., a net rental income of approximately $15000 per annum. The person contributes $200/week=$10400 per annum.

The net rental income and the person's contribution, totalling approximately $25000 per annum, are paid on the loan line of credit so that the investment property is fully owned within 8-10 years (dependent on the interest rate). Assuming full payment in just over 8 years, a $90,000 total contribution by the person, at a “painless” rate of $200 per week results in the ownership of an asset with $200,000 (plus any capital gains which have accrued).

The person reaches his/her retirement age, and has the fully owned investment property (and the fully owned primary residence). NB: The person has paid less than 50% of the purchase price of the property; and at a 7.2% per annum growth rate, the property would be worth approximately $400,000—a gross profit of approximately $300,000 on their outlays. That means the outlay of $200 per week has returned a profit of $562 per week ($400,000÷520 weeks=$762 per week). This is a tax-free profit, which would be extremely difficult to equal.

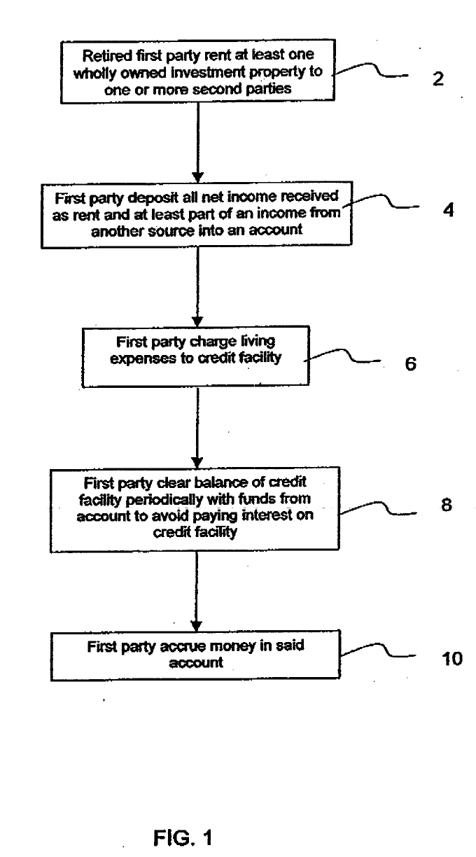

The steps of the preferred method are illustrated in FIG. 1.

The (new retired) person/first party rents the investment property to one or more second parties (2). The first party deposits all net rental income into an account, which preferably pays interest, and further preferably deposits into that account at least part of any income from other source(s), eg., an index-linked pension, into the account (4). Preferably, the first party structures his/her finances so that they receive at least the non-cash benefits of the pension, eg., health care card, transport concessions, Seniors Card, etc.

The first party charges all living expenses to a credit facility (6), eg., a credit card with a nil-interest period or a revolving line of credit.

Periodically, eg., monthly, the first party draws funds from the account to avoid (or at least minimise) paying interest on the credit facility (8). The remaining balance in the account is allowed to accrue (10). NB: The first party can draw additional funds from the account, eg., for travel/holiday expenses as required.

Annexures A and B illustrate how the method may be effected in a practical example.

Annexure A illustrates the purchase of the investment property valued at $240000, where the first party contributes approximately $220 per week and the property is paid out within 10 years (120 months). The property value has increased to approximately $481,000, is., a 100% capital gain. The person has outlaid less than one-quarter of the purchase price. The $220 per week saving returns a profit of $705 per week ($481,000÷520 weeks $925 per week, tax free).

Annexure B illustrates the retirement phase, assuming living costs of approximately $30,000 per annum; initial rental income of $1300 per month and pension income of approximately $1200 per month, for a net income just under $2500 per month. The calculations assume an interest rate received of 1.50%; an interest rate of 7.0% on the line of credit; an annual cost of living increase of 4.00%; and a capital growth rate of 7.20%.

The “Summary” shows that from Year 1 to Year 20, the person's net worth has increased from $240,000 to approximately $970,000, on an investment property valued at $240,000 at the commencement of year 1.

If desired, the first person can draw from the account, or against their equity In the property, to pay, eg., holiday or other discretionary costs, but the net worth is reduced. Any equity drawn is tax-free.

The examples in Annexures A and B are by way of illustration only, and the amounts applicable to any individual will be dependent on their circumstances, eg., number of investment properties rented/pension or other income received/annual living expenses, etc.

Using this method, the person does not have to sell the family home; and they have control of their ingoings/outgoings.

The supporting software provided to users of the invention, lets them see, at any time, where they are, how secure they are; and can be adjusted to suit changing economic and/or personal circumstances.

Benefits of the invention include:

1) it builds wealth and security for a small investment;

2) all capital growth is tax-free;

3) all equity spent is tax-free;

4) the investor does not pay inflated prices for the property(ies);

5) the investor is in total control and they can see their actual/future position at any time;

6) even if the property shoes little/nil growth, the person still makes money;

7) the location of the property is not overly important;

8) the method of the invention outperforms other known investments; and

9) the method of the investor has been proven to work mathematically;

10) the faster equity is built, the safer the investor—by paying, eg., $200 per week into the loan creates a self-funding investment in a short period, allowing the investor to build up a portfolio, if they so desire. This is less risky than buying a number of properties over a short time;

11) the method can be applied for self-employed people, who pay their tax and GST into the loan, creating equity even faster; and

12) as there is no tax payable yearly, a the property value increases, the method of the present invention makes a better option for investors than having to pay tax in yearly growth of other forms of investment.

As an alternative to one or more investment properties, the method may be applied to the purchase of shares and like securities, and the dividends/payments derived therefrom can be applied to payments to the credit facility.

The comparable income/expenses are illustrated in Annexure C.

The person receives income via dividends, etc., and should also enjoy capital growth in the value of shares/securities held.

Throughout the specification, the aim has been to describe the invention without limiting the invention to any one embodiment or specific collection of features. Persons skilled in the relevant art may realise variations from the specific embodiments that will nonetheless fall within the scope of the invention.

1. A method of saving or investing money including the steps of:
a first party renting at least one wholly owned investment property to one or more second parties;
said first party depositing all net income received as rent for renting said at least one investment property, and (optionally) at least part of an income from another source, into an account;
said first party charging their living expenses/outgoings to a credit facility and clearing the balance of the credit facility periodically with funds from said account to avoid, or minimise, paying interest on said credit facility; and
said first party accruing money in said account.

2. A method of saving or investing money including the steps of:
a first party purchasing shares or like securities and depositing all net income received as dividends or like financial payments from said shares or like securities, and (optionally) at least part of an income from another source, into an account, said first party charging their living expenses/outgoings to a credit facility and clearing the balance of the credit facility periodically with funds from said account to avoid, or minimise, paying interest on said credit facility; and
said first party accruing money in said account.

3. A method as claimed in claim 2 wherein:
shares and like securities includes shares, deposit receipts, options and fixed- and variable-interest debentures issued by governments, banks, other financial institutions and corporations.

4. A method as claimed in claim 1 wherein:
the first party fully owns their own residential property and purchases the, or each, investment property, or the shares or like securities by regular payments prior to retirement.

5. A method as claimed in claim 1 wherein:
the investment property is rented and all net rental income is applied to the loan/credit facility used to purchase the property.

6. A method as claimed in claim 1 wherein:
the first party does not raise any other borrowings against their equity in the, or each, investment property, or the shares or like securities, to achieve the maximum capital growth thereon.

7. A method as claimed in claim 1 wherein:
the income from another source includes an index-linked part pension.

8. A method as claimed in claim 7 wherein:
the first party structures his/her finances so that non-cash benefits of the pension are not lost to provide health care, transport concessions and the like.

9. A method as claimed in claim 1 wherein:
the credit facility is a credit card with an interest-force period, or a revolving line of credit or other suitable credit facility which does not apply redraw fees.

10. A method as claimed in claim 2 wherein:
the first party fully owns their own residential property and purchases the, or each, investment property, or the shares or like securities by regular payments prior to retirement.

11. A method as claimed in claim 2 wherein:
the first party does not raise any other borrowings against their equity in the, or each, investment property, or the shares or like securities, to achieve the maximum capital growth thereon.

12. A method as claimed in claim 2 wherein:
the income from another source includes an index-linked part pension.

13. A method as claimed in claim 2 wherein:
the credit facility is a credit card with an interest-force period, or a revolving line of credit or other suitable credit facility which does not apply redraw fees.
